(19) United States
(12) Patent Application Publication
(10) Pub. No.: US 2008/0259459 A1
(43) Pub. Date: Oct. 23, 2008

(54) REFLECTIVE FILTER

(75) Inventors: WEN-CHUN WANG, Taichung City (TW); CHIN-PEI HWANG, Kaohsiung City (TW); CHIN-CHANG LIU, Taichung County (TW); YI-SHU CHEN, Taichung City (TW); KUAN-LIN CHEN, Changhua County (TW)

Correspondence Address: WPAT, PC, 7225 BEVERLY ST., ANNANDALE, VA, 22003, US

(73) Assignee: WINTEK CORPORATION, TAICHUNG (TW)

(21) Appl. No.: 12/104,693

(22) Filed: Apr. 17, 2008

(30) Foreign Application Priority Data
Apr. 23, 2007 (TW) 096114256

(51) Int. Cl. G02B 5/28; G02B 1/10

(52) U.S. Cl. 359/588; 359/589

(57) ABSTRACT

A reflective filter including a substrate and an optical film structure disposed on the substrate is provided. The optical film structure includes a reflective layer, a spacing layer, a transflective layer and a transparent layer in sequence. Depending on the reflection and interference phenomenon form the layers of the optical film structure, a colored light within narrow band could be filtered by the reflective filter in order to enhance the color saturation of an image.

### FIELD OF THE INVENTION

The present invention relates to a filter, and more particularly, to a reflective filter.

### BACKGROUND OF THE INVENTION

The demand for liquid crystal displays (LCDs) has been increasing rapidly in recent years in conjunction with the advance of video communication technology, especially for those being employed as displaying device in electrical consumer products, such as cellular phones, digital watches, personal digital assistants (PDAs), etc. In responding to this demand, high priority is now being given to establishing means for supplying low-power solutions for such liquid crystal displays and thus many researches have invest their efforts in the development of reflective LCDs or transflective LCDs.

Generally, for enhancing its color imaging performance, both of the aforesaid reflective LCD or transflective LCD are structured with a color filter. Please refer to FIG. 1, which shows a conventional color filter. The color filter of FIG. 1 is comprised of a substrate 110, a reflective film 120, a black matrix 130, a plurality of resin patterns containing red pigment 140, a plurality of resin patterns containing green pigment 150, and a plurality of resin patterns containing blue pigment 160. It is noted that the disposition of the reflective film 120 is for enhancing the efficiency of each resin pattern. The reflective film 120 is formed on the substrate 110 while the black matrix 130 is formed on the reflective film 120 for defining an array of pixels, in that the resin patterns containing red, green and blue pigments are disposed in respective and used for filtering and converting light incident thereon into red, green and blue light.

Taking one resin pattern containing red pigment 140, referring hereinafter as red resin pattern, for example, it will absorb green and blue light while only allowing red light to pass therethrough. However, it is noted that after filtered by the color filter 100, only about one third of a white beam is actually used for color display so that it is the cause of poor light utilization efficiency. In addition, the color filter demonstrate poor spectrum resolution as it is generated by the filtering of those red, green, and blue resin patterns 140,150, 160, and thus, it will cause an image to demonstrate unsatisfactory color saturation.

For improvement, a reflective color filter is provided as disclosed in WO9517690, entitled “Color Filter Array”, which filters light according to the Fabry-Perot cavity interference. Nevertheless, as wave bands of colored light generated thereby are still comparatively too wide, that is, it can not generate narrow-banded red, green, and blue light beams, so that the aforesaid reflective color filter still demonstrate poor spectrum resolution and thus, it will still cause an image to demonstrate unsatisfactory color saturation.

### SUMMARY OF THE INVENTION

The primary object of the present invention is to provide a reflective filter with improved light utilization efficiency, capable of producing red, green and blue light of improved spectrum resolution so as to enhance color saturation of an image.

To achieve the above object, the present invention provides a reflective filter, comprising: a substrate; and an optical film structure including a reflective layer, a spacing layer, a transflective layer and a transparent layer in sequence; wherein the reflective layer is disposed on the substrate; the spacing layer is disposed on the reflective layer; the transflective layer is disposed on the spacing layer; and the transparent layer is disposed on the transflective layer.

In an exemplary embodiment of the invention, the reflective layer can be made of a material selected from the group consisting of aluminum (Al), silver (Ag), platinum (Pt), and the alloys thereof; while the transflective layer can be made of a material selected from the group consisting of chromium (Cr), platinum (Pt), nickel (Ni), palladium (Pd), and the alloys thereof.

In another exemplary embodiment of the invention, an array of pixels, referring as pixel array, is defined in the optical film structure while the pixel array is composed of a plurality of red light areas, a plurality of green light areas and a plurality of blue light areas, in which the thicknesses of different portions of the spacing layer with respect to the red light, the green light and the blue light areas are different from each other.

In another exemplary embodiment of the invention, a plurality of gaps is structured in the pixel array while enabling each gap being formed between any two neighboring pixels of the pixel array.

In another exemplary embodiment of the invention, the reflective filer further comprises a plurality of light-shield structures, being disposed on the substrate at positions relating to those gaps formed between pixels of the pixel array.

In another exemplary embodiment of the invention, in addition, a plurality of openings are structured in the optical film structure while enabling each opening to penetrate the whole optical film structure and reach the substrate.

In another exemplary embodiment of the invention, the spacing layer is composed of a first spacing film and a second spacing film in sequence, in that the first spacing film is disposed on the reflective layer while the second spacing film is disposed on the first spacing film.

To sum up, in the reflective filter of the invention, after lights of a light source are traveling trough the transparent layer, the transflective layer and the spacing layer to be reflected by the reflective layer, the reflected lights will interfere with each other in the transparent layer where they are purified into narrow-banded colored lights, by which the reflective filter is capable of producing colored lights of improved spectrum resolution so as to enhance color saturation of an image, In addition, as the filtering of the reflective filter of the invention is performed by an non-absorption fashion, so that there is less light being lost in the filtering process and thus the light utilization efficiency is enhanced.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic view of a conventional color filter.

FIG. 2 is a schematic diagram illustrating a reflective filter according to an exemplary embodiment of the invention.

FIG. 3 is a schematic diagram illustrating a reflective filter according to another exemplary embodiment of the invention.

FIG. 4a˜FIG. 4c are experimental charts of the reflective filter of FIG. 3, whereas the reflective filter is defined by the parameters indicated in Table 1.

FIG. 5a˜FIG. 5c are experimental charts of the reflective filter of FIG. 3, whereas the reflective filter is defined by the parameters indicated in Table 2.

FIG. 6a˜FIG. 6c are experimental charts of the reflective filter of FIG. 3, whereas the reflective filter is defined by the parameters indicated in Table 3.

FIG. 7a˜FIG. 7c are experimental charts of the reflective filter of FIG. 3, whereas the reflective filter is defined by the parameters indicated in Table 4.

FIG. 8a˜FIG. 8c are experimental charts of the reflective filter of FIG. 3, whereas the reflective filter is defined by the parameters indicated in Table 5.

FIG. 9a˜FIG. 9c are experimental charts of the reflective filter of FIG. 3, whereas the reflective filter is defined by the parameters indicated in Table 6.

FIG. 10a˜FIG. 10c are experimental charts of the reflective filter of FIG. 3, whereas the reflective filter is defined by the parameters indicated in Table 7.

FIG. 11 is a schematic diagram illustrating a reflective filter according to yet another exemplary embodiment of the invention.

FIG. 12a˜FIG. 12c are experimental charts of the reflective filter of FIG. 11, whereas the reflective filter is defined by the parameters indicated in Table 8.

FIG. 13 is a schematic diagram illustrating a reflective filter according to further another exemplary embodiment of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

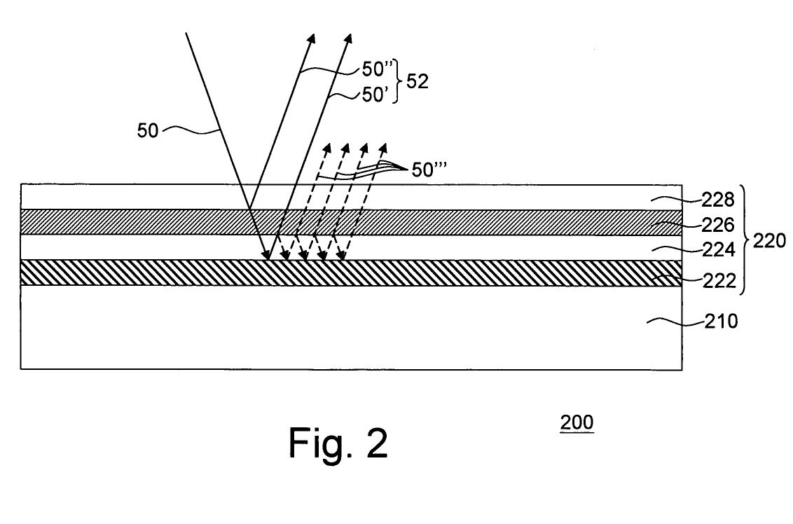

Please refer to FIG. 2, which is a schematic diagram illustrating a reflective filter according to an exemplary embodiment of the invention. As shown in FIG. 2, a reflective filter 200 is comprised of: a substrate 210 and an optical film structure 220 disposed on the substrate 210. The optical film structure 220 is further composed of a reflective layer 222, a spacing layer 224, a transflective layer 226 and a transparent layer 228 in sequence; wherein the reflective layer 222 is disposed on the substrate 210; the spacing layer 224 is disposed on the reflective layer 221; the transflective layer 226 is disposed on the spacing layer 224; and the transparent layer 226 is disposed on the transflective layer 228.

When a light beam 50 impinges on the reflective filter 200, a portion of the light beam 50 will travel passing trough the transparent layer 228, the transflective layer 226 and the spacing layer 224 sequentially and strike upon the reflective layer 222 where it is reflected as a reflected light beam 50′, while another portion of the light beam 50 is reflected by the transflective layer 226 as another reflected light beam 50″. Thereafter, both of the two reflected light beams 50′, 50″ are shooting out of the reflective filter 200 following their respective reflected paths while interfering with each other as they are traveling following the paths, forming a colored light beam 52 by the interference to be discharged out of the reflective filter 200. In fact, other reflected light beams 50′″ caused by secondary or multiple reflection will also interfere with each other. However, those interferences between reflected light beams 50′″ is not going to affect the color characteristics of light reflected by the reflective filter 200 as significant as that of the two reflected light beams 50′, 50″. Thus, it is concluded that the reflective filter 200 is capable of filtering the light beam 50 and then generating a colored light beam 52 of high resolution accordingly.

As the light beam 50 can be considered to be converted into the colored light beam 52 by the reflective filter 200 based on optical interference, no significant energy loss will occur during the process. That is, the light utilization efficiency of the reflective filter 200 is higher than those other conventional color filters as it is not going to cause a mass light loss.

In this exemplary embodiment, the reflective layer 222 can be made of a material selected from the group consisting of aluminum (Al), silver (Ag), platinum (Pt), and the like; while the transflective layer 226 can be made of a material selected from the group consisting of chromium (Cr), platinum (Pt), nickel (Ni), palladium (Pd), and the like. In addition, the refractive index of the spacing layer 224 is ranged between 1.2 and 2.6, which is made of a material selected from the group consisting of an oxide, a nitride, a fluoride and a transparent organic substance. In detail, the spacing layer 224 is made of a material selected from the group consisting of indium tin oxide (ITO), silicon Oxide, silicon nitride, MgF₂, LiF, Al₂O₃, ZrO₂, Nb₂O₅, and polyimide, whichever is capable of causing the light beam 50 to gain in the optical interference.

Moreover, the extinction coefficient of the transparent layer 228 is smaller than 0.2 while its refractive index is ranged between 1.2˜2.6. The transparent layer is made of a material selected from the group consisting of an oxide and a transparent organic substance, such as indium tin oxide (ITO), indium zinc oxide (IZO), Aluminum zinc oxide (AZO), TiO₂ and polyimide, etc., whichever is capable of causing the interference between the two reflected light beams 50′, 50″ while narrowing the bandwidth of the resulting colored light beam 52.

It is noted that the foregoing description only depicting the process of using the reflective filter to generate a monochromatic light. However, by structuring an array of pixel in the optical film structure 220, the reflective filter 200 is capable of generating light beams of various colors.

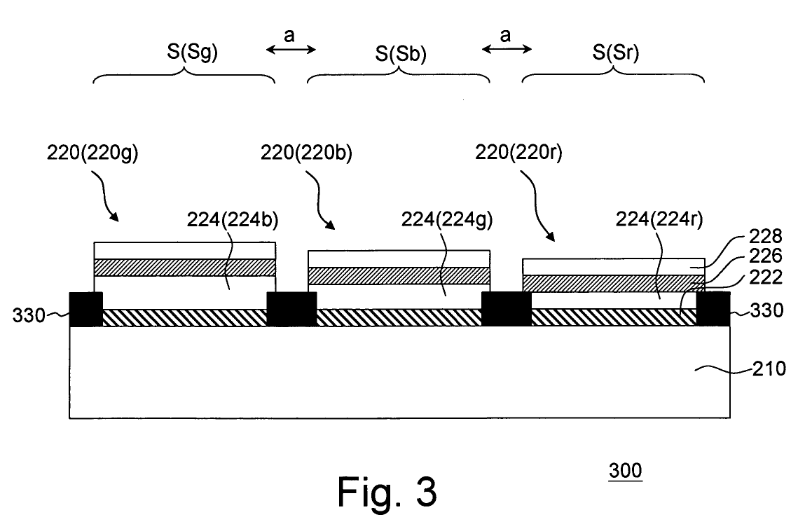

Please refer to FIG. 3, which is a schematic diagram illustrating a reflective filter according to another exemplary embodiment of the invention. For clarity, the components of the reflective filter 300 of FIG. 3 which are the same as those in the reflective filter 200 of FIG. 2 will adopt the same numbering. As shown in FIG. 3, an array of pixels S, referring as pixel array, is defined in the optical film structure 220, which is composed of a plurality of red light areas Sr, a plurality of green light areas Sg and a plurality of blue light areas Sb, while the thicknesses of different portions of the spacing layer 224 with respect to the red light, the green light and the blue light areas, referring as 224r, 224g, 224b, are different from each other. The table 1 listed as following illustrates experimental parameters of a spacing layer 224 used in the reflective filter 300.

TABLE 1

| | | layer | layer | layer |
|---|---|---|---|---|
| | | thickness | thickness | thickness |
| | | corresponding | corresponding | corresponding |
| | | to blue light | to green light | to red light |
| | material | areas Sb (nm) | areas Sg (nm) | areas Sr (nm) |
| Reflective | AlNd | 150 | 150 | 150 |
| layer | | | | |
| Spacing | Si₃N₄ | 208 | 225 | 162 |
| layer | | | | |
| Transflective | Cr | 8.6 | 8.6 | 8.6 |
| layer | | | | |
| Transparent | ITO | 53 | 53 | 53 |
| layer | | | | |

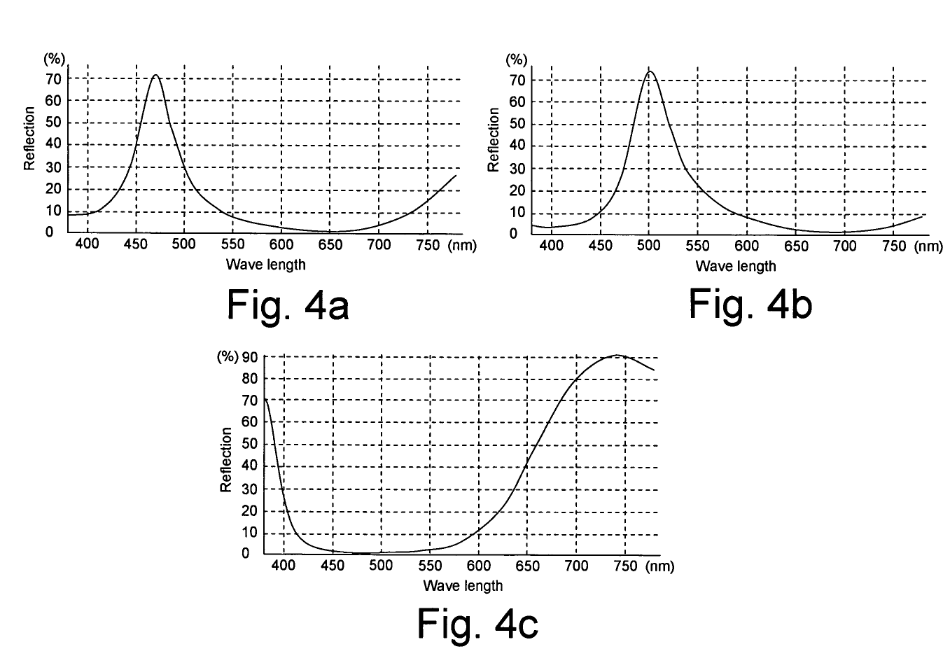

Please refer to FIG. 4a˜FIG. 4c, which are experimental charts of the reflective filter of FIG. 3, whereas the reflective filter is defined by the parameters indicated in Table 1. As shown, the horizontal coordinate represents wavelengths of reflected light while the vertical coordinate represents reflections, in addition, the chart of FIG. 4a is describing a reflected light generated from the blue light areas Sb, the chart of FIG. 4b is describing a reflected light generated from the green light areas Sg, and the chart of FIG. 4c is describing a reflected light generated from the red light areas Sr. As shown in FIG. 4a˜FIG. 4c, any one of those blue, green and red light areas Sb, Sg, Sr can only reflected and thus generate a corresponding colored light of narrow band while only a peak is included in such narrow band. Therefore, the reflective filter is capable of generating colored light of high resolution to be used for greatly enhancing the color saturation of an image. Moreover, as the reflections of both the blue and green light are above 70% while that of the red light is more than 90%, it indicates that the light utilization efficiency of the aforesaid reflective filter 300 is much better than those conventional color filters.

Although the reflective filter 300 showing in the exemplary embodiment of FIG. 3 is designed to filter and generate only red, green and blue light, the number as well as the bands of the colored light capable of being generated by the reflective filter of the invention are not limited thereby. It is feasible for those skilled in the art to adjust those parameters disclosed in table 1 while matching those with the thickness, the material used, the refractive index and light extinction coefficient of the transparent layer, a variety of colored lights of narrow band can be produced.

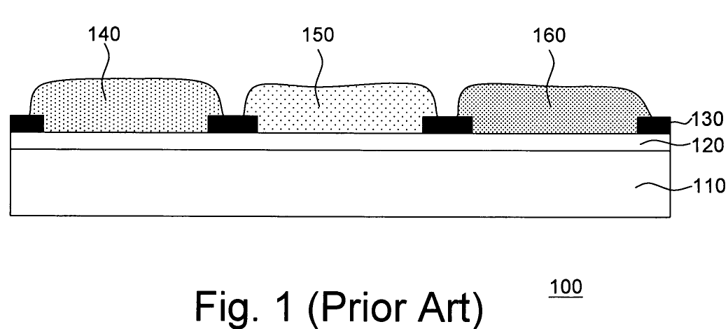

As shown in FIG. 3, in order to prevent those colored light beams to have affect upon each other, a plurality of gaps a are structured in the pixel array while enabling each gap a being formed between any two neighboring pixels of the pixel array in a manner that each of those blue, green and red light areas Sb, Sg, Sr are isolated from each other. Furthermore, the reflective filer 300 is further comprised of a plurality of light-shield structures 330, which are structured similar to the black matrix 130 of FIG. 1 and are disposed on the substrate at positions relating to those gaps a formed between pixels of the pixel array. The light-shield structures 330 can be made of a light-shielding material, such as black resin, or metals like chromium, or lead, etc. Each of the light-shield structures 330 is functioned to absorb disorderly light beams so that each of those blue, green and red light areas Sb, Sg, Sr is able to produce high quality monochromatic light in respective.

To go a step further, the principle of the reflective filter of the invention is to design and dispose a matching pair of the transflective layer 226 and the transparent layer 228 in a manner that they can cause colored lights to interfere and thus purify into a narrow-banded colored light of a single peak.

The table 2, table 3, table 4, table 5, table 6, table 7 listed as following illustrate other experimental parameters of a spacing layer 224 used in the reflective filter 300.

TABLE 2

| | | layer | layer | layer |
|---|---|---|---|---|
| | | thickness | thickness | thickness |
| | | corresponding | corresponding | corresponding |
| | | to blue light | to green light | to red light |
| | material | areas Sb (nm) | areas Sg (nm) | areas Sr (nm) |
| Reflective | Ag | 200 | 200 | 200 |
| layer | | | | |
| Spacing | SiO₂ | 284 | 304 | 200 |
| layer | | | | |
| Transflective | Cr | 8.4 | 8.4 | 8.4 |
| layer | | | | |
| Transparent | TiO₂ | 37.02 | 37.02 | 37.02 |
| layer | | | | |

TABLE 3

| | | layer | layer | layer |
|---|---|---|---|---|
| | | thickness | thickness | thickness |
| | | corresponding | corresponding | corresponding |
| | | to blue light | to green light | to red light |
| | material | areas Sb (nm) | areas Sg (nm) | areas Sr (nm) |
| Reflective | Ag | 150 | 150 | 150 |
| layer | | | | |
| Spacing | SiO₂ | 300 | 325 | 235 |
| layer | | | | |
| Transflective | Cr | 8.4 | 8.4 | 8.4 |
| layer | | | | |
| Transparent | TiO₂ | 54 | 54 | 54 |
| layer | | | | |

TABLE 4

| | | layer | layer | layer |
|---|---|---|---|---|
| | | thickness | thickness | thickness |
| | | corresponding | corresponding | corresponding |
| | | to blue light | to green light | to red light |
| | material | areas Sb (nm) | areas Sg (nm) | areas Sr (nm) |
| Reflective | Ag | 200 | 200 | 200 |
| layer | | | | |
| Spacing | SiO₂ | 290 | 310 | 220 |
| layer | | | | |
| Transflective | Cr | 8.4 | 8.4 | 8.4 |
| layer | | | | |
| Transparent | TiO₂ | 48.47 | 48.47 | 48.47 |
| layer | | | | |

TABLE 5

| | | layer | layer | layer |
|---|---|---|---|---|
| | | thickness | thickness | thickness |
| | | corresponding | corresponding | corresponding |
| | | to blue light | to green light | to red light |
| | material | areas Sb (nm) | areas Sg (nm) | areas Sr (nm) |
| Reflective | Ag | 200 | 200 | 200 |
| layer | | | | |
| Spacing | SiO₂ | 202 | 223 | 150 |
| layer | | | | |
| Transflective | Cr | 8.4 | 8.4 | 8.4 |
| layer | | | | |
| Transparent | TiO₂ | 70 | 70 | 70 |
| layer | | | | |

TABLE 6

| | | layer | layer | layer |
|---|---|---|---|---|
| | | thickness | thickness | thickness |
| | | corresponding | corresponding | corresponding |
| | | to blue light | to green light | to red light |
| | material | areas Sb (nm) | areas Sg (nm) | areas Sr (nm) |
| Reflective | Ag | 200 | 200 | 200 |
| layer | | | | |
| Spacing | SiO₂ | 200 | 216 | 140 |
| layer | | | | |
| Transflective | Cr | 8.4 | 8.4 | 8.4 |
| layer | | | | |
| Transparent | TiO₂ | 42 | 42 | 42 |
| layer | | | | |

TABLE 7

| | | layer | layer | layer |
|---|---|---|---|---|
| | | thickness | thickness | thickness |
| | | corresponding | corresponding | corresponding |
| | | to blue light | to green light | to red light |
| | material | areas Sb (nm) | areas Sg (nm) | areas Sr (nm) |
| Reflective | Ag | 150 | 150 | 150 |
| layer | | | | |
| Spacing | SiO₂ | 213.69 | 235 | 172 |
| layer | | | | |
| Transflective | Cr | 8.6 | 8.6 | 8.6 |
| layer | | | | |
| Transparent | TiO₂ | 51.12 | 51.12 | 51.12 |
| layer | | | | |

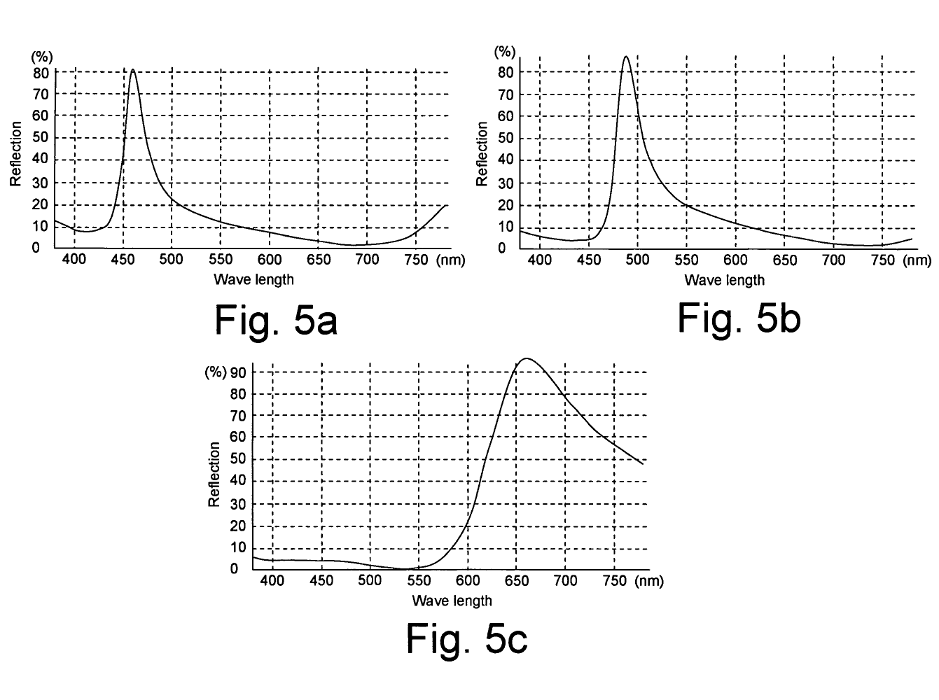

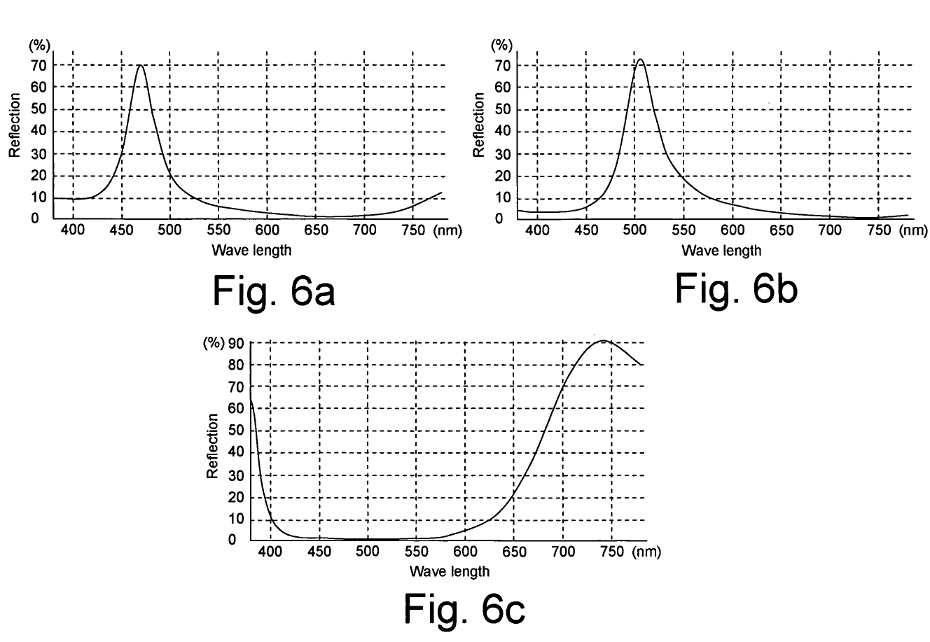

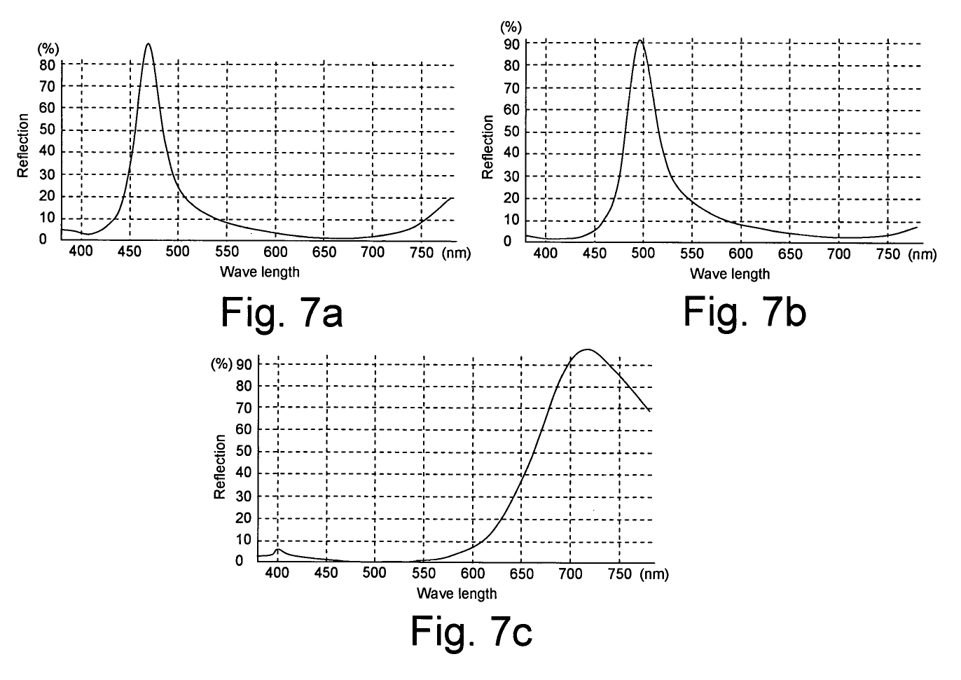

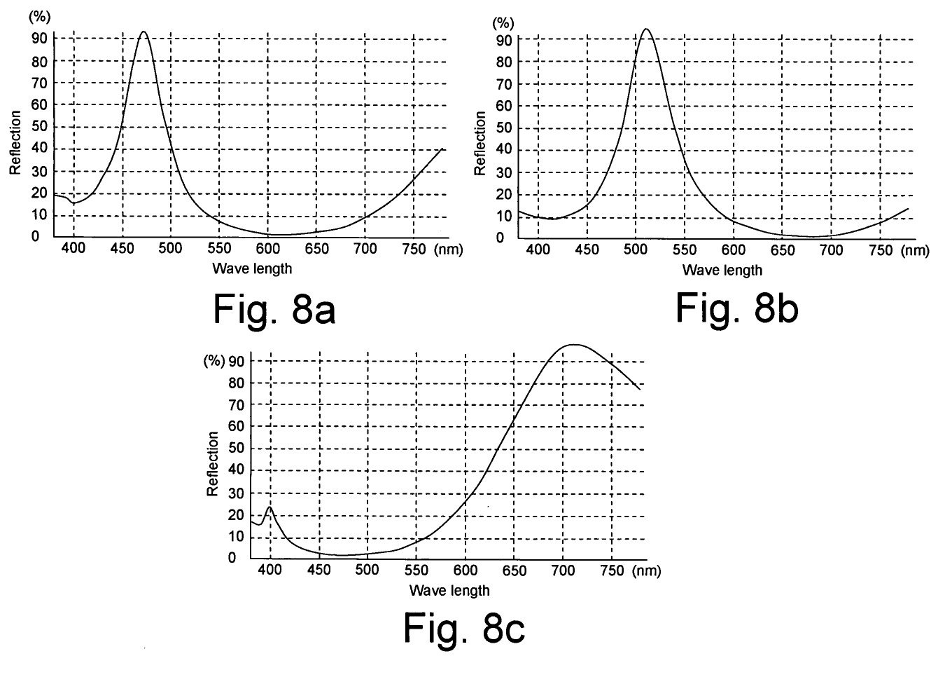

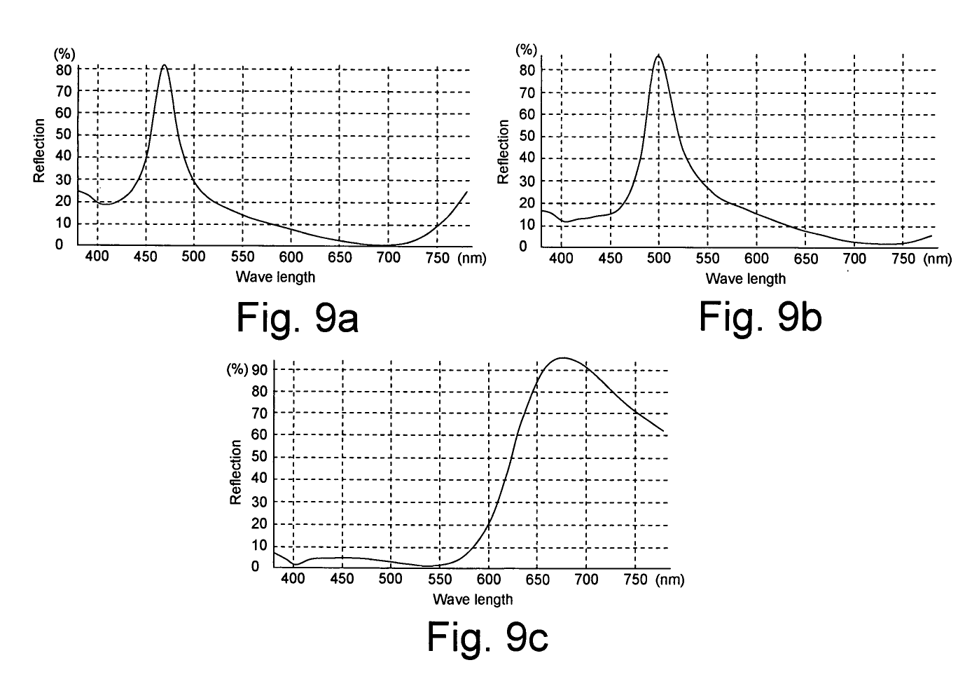

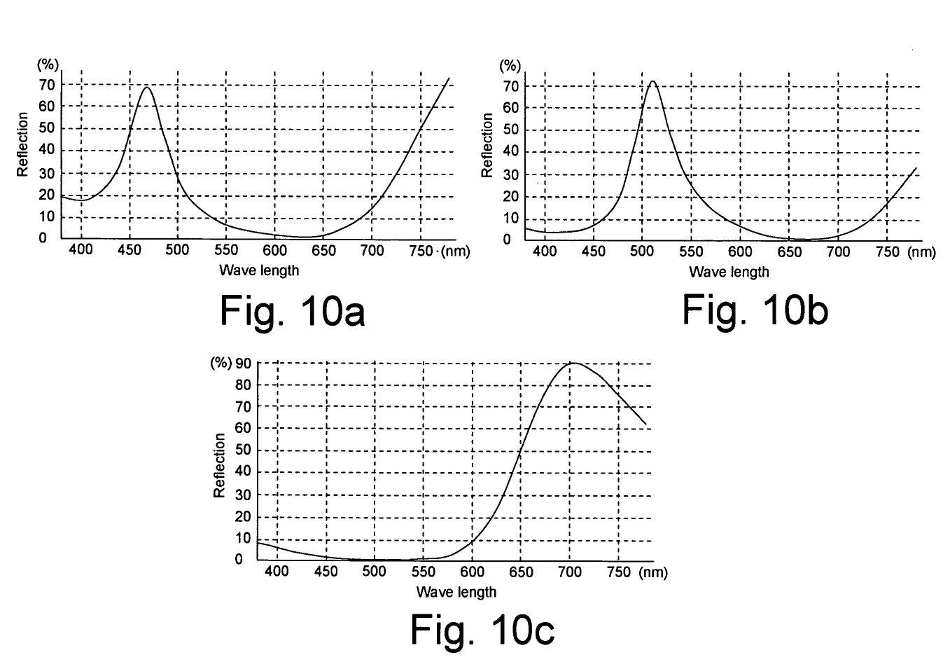

Please refer to FIG. 5a˜FIG. 5c, FIG. 6a˜FIG. 6c, FIG. 7a˜FIG. 7c, FIG. 8a˜FIG. 9c, FIG. 9a˜FIG. 9c and FIG. 10a˜FIG. 10c, which are experimental charts of the reflective filter of FIG. 3, whereas the reflective filter is defined by the parameters indicated in Table 2, Table 3, Table 4, Table 5, Table 6, Table 7 in respective. As shown, the horizontal coordinate represents wavelengths of reflected light while the vertical coordinate represents reflections, in addition, the charts of FIG. 5a˜10a are describing a reflected light generated from the blue light areas Sb, the charts of FIG. 5b˜10b are describing a reflected light generated from the green light areas Sg, and the charts of FIG. 5c˜10c are describing a reflected light generated from the red light areas Sr. As shown in those figures, any one of those blue, green and red light areas Sb, Sg, Sr can only reflected and thus generate a corresponding colored light of narrow band while only a peak is included in such narrow band. Therefore, all the aforesaid reflective filters are capable of generating colored light of high resolution to be used for greatly enhancing the color saturation of an image. Moreover, the reflections of other lights whose wavelength is not corresponding to any of that defined by the reflection of the blue, green and red light areas Sb, Sg, Sr are all lower than 20%, so that it can be concluded that the colored light filtered by the reflective filter of the invention is highly purified and thus the color mixing phenomenon is prevented. In addition, as the reflections of the blue, the green, and the red light are above 90%, it indicates that the light utilization efficiency of the aforesaid reflective filter 300 is much better than those conventional color filters.

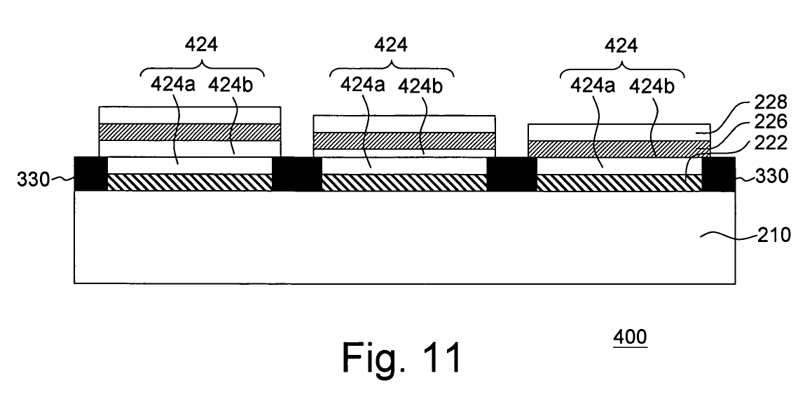

In all the aforesaid exemplary embodiments, the spacing layers are all a single layer structure, designed for light to interfere therein. However, it can be a layer composed of multiple films, whereas different films thereof can be made of different materials. Please refer to FIG. 11, which is a schematic diagram illustrating a reflective filter according to yet another exemplary embodiment of the invention. In FIG. 11, the reflective filter 400 is structured similar to the reflective filter 300 shown in FIG. 3, the differences between the two is that the spacing layer 424 of the reflective filter 400 is composed of a first spacing film 424a and a second spacing film 424b in sequence, whereas the first spacing film 424a is sandwich between the reflective layer 222 and the second spacing film 424b.

As the two spacing films 424a, 424b are made of different material, the optical interference can be repetitively caused in such spacing layer 424 for achieving a specific gain before traveling into the transflective layer 226 for generating a corresponding specific colored light. The table 8 listed as following illustrates experimental parameters of a spacing layer 224 used in the reflective filter 300.

TABLE 8

| | | layer | layer | layer |
|---|---|---|---|---|
| | | thickness | thickness | thickness |
| | | corresponding | corresponding | corresponding |
| | | to blue light | to green light | to red light |
| | material | areas Sb (nm) | areas Sg (nm) | areas Sr (nm) |
| Reflective | AlNd | 150 | 150 | 150 |
| layer | | | | |
| First spacing | Si₃N₄ | 208 | 208 | 208 |
| layer | | | | |
| Second | LiF | 0 | 23 | 110 |
| spacing | | | | |
| layer | | | | |
| Transflective | Cr | 8.6 | 8.6 | 8.6 |
| layer | | | | |
| Transparent | ITO | 53 | 53 | 53 |
| layer | | | | |

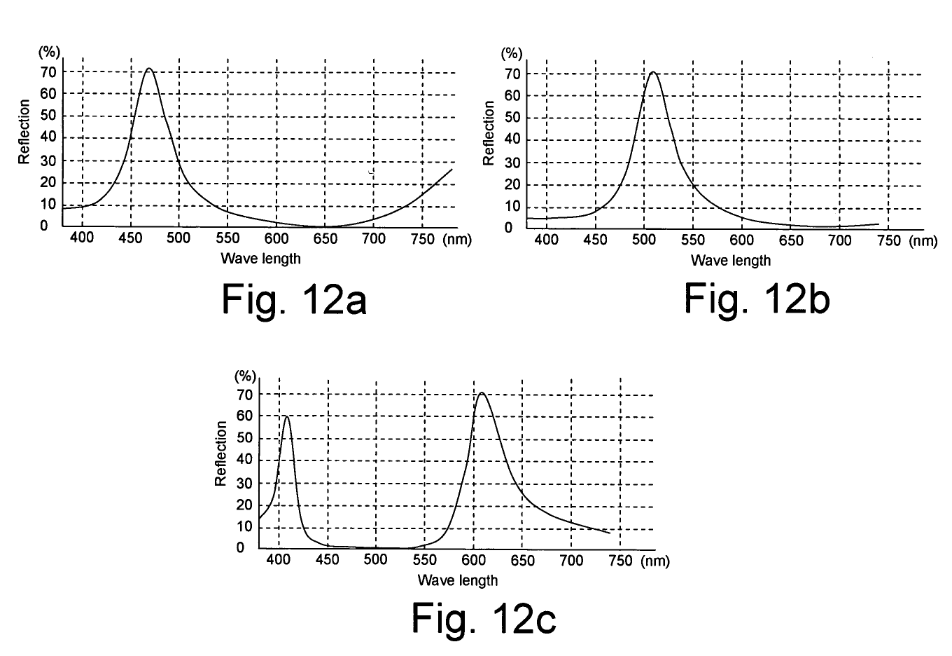

Please refer to FIG. 12a˜FIG. 12c, which are experimental charts of the reflective filter of FIG. 11, whereas the reflective filter is defined by the parameters indicated in Table 8. As shown, the horizontal coordinate represents wavelengths of reflected light while the vertical coordinate represents reflections, in addition, the chart of FIG. 12a is describing a reflected light generated from the blue light areas Sb, the chart of FIG. 12b is describing a reflected light generated from the green light areas Sg, and the chart of FIG. 12c is describing a reflected light generated from the red light areas Sr. As shown in FIG. 12a˜FIG. 12c, the reflective filter demonstrates good optic characteristics the same as those shown in the previous embodiments.

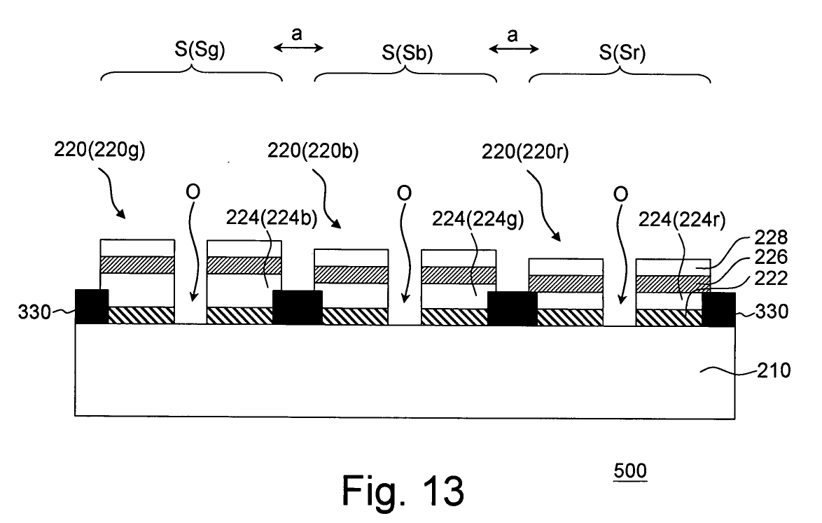

Please refer to FIG. 13, which is a schematic diagram illustrating a reflective filter according to further another exemplary embodiment of the invention. As shown in FIG. 13, the reflective filter 500 is structured similar to the reflective filter 300 of FIG. 3, the difference between the two is that a plurality of openings O are structured in the optical film structure 220 while enabling each opening O to penetrate the whole optical film structure and reach the substrate 210. By the aforesaid openings O, the reflective filter 500 not only is able to filter and reflect light, but also it will allow light from a light source disposed beneath the substrate 210 to pass therethrough directly, thereby, it is a semi-permeable reflective filter.

To sum up, the reflective filter has the following advantages:
(1) As the spacing layer sandwiched between the reflective layer and the transflective layer is able to cause optical interference and the transparent layer is designed to further purify the light traveling therethrough, the reflective filter of the exemplary embodiment is able to filter and thus generate narrow-banded colored light of high resolution to be used for enhancing color saturation of an image.
(2) As the filtering of the reflective filter of the invention is performed in an optical interfering manner, there is less light being lost in the filtering process and thus the light utilization efficiency is enhanced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A reflective filter, comprising:
a substrate; and
an optical film structure, including:
a reflective layer, disposed on the substrate;
a spacing layer, disposed on the reflective layer;
a transflective layer, disposed on the spacing layer; and
a transparent layer, disposed on the transflective layer.

2. The reflective filter of claim 1, wherein the reflective layer can be made of a material selected from the group consisting of aluminum (Al), silver (Ag), platinum (Pt), and the alloys thereof.

3. The reflective filter of claim 1, wherein the refractive index of the spacing layer is ranged between 1.2 and 2.6.

4. The reflective filter of claim 1, wherein the spacing layer is made of a material selected from the group consisting of an oxide, a nitride, a fluoride and a transparent organic substance.

5. The reflective filter of claim 4, wherein the spacing layer is made of a material selected from the group consisting of indium tin oxide (ITO), silicon Oxide, silicon nitride, MgF₂, LiF, Al₂O₃, ZrO₂, Nb₂O₅, and polyimide.

6. The reflective filter of claim 1, wherein the transflective layer can be made of a material selected from the group consisting of chromium (Cr), platinum (Pt), nickel (Ni), palladium (Pd), and the alloys thereof.

7. The reflective filter of claim 1, wherein the extinction coefficient of the transparent layer is smaller than 0.2.

8. The reflective filter of claim 1, wherein the refractive index of the transparent layer is ranged between 1.2 and 2.6.

9. The reflective filter of claim 1, wherein the transparent layer is made of a material selected from the group consisting of an oxide and a transparent organic substance.

10. The reflective filter of claim 9, wherein the transparent layer is made of a material selected from the group consisting of indium tin oxide (ITO), indium zinc oxide (IZO), Aluminum zinc oxide (AZO), TiO₂ and polyimide.

11. The reflective filter of claim 1, wherein an array of pixels, referring as pixel array, is defined in the optical film structure.

12. The reflective filter of claim 11, wherein the pixel array is composed of a plurality of red light areas, a plurality of green light areas and a plurality of blue light areas, while the thicknesses of different portions of the spacing layer with respect to the red light, the green light and the blue light areas are different from each other.

13. The reflective filter of claim 11, wherein a plurality of gaps are structured in the pixel array while enabling each gap being formed between any two neighboring pixels of the pixel array.

14. The reflective filter of claim 13, wherein the reflective filer further comprises a plurality of light-shield structures, being disposed on the substrate at positions relating to those gaps formed between pixels of the pixel array.

15. The reflective filter of claim 1, wherein a plurality of openings are structured in the optical film structure while enabling each opening to penetrate the whole optical film structure and reach the substrate.

16. The reflective filter of claim 11, wherein a plurality of openings are structured in the optical film structure while enabling each opening to penetrate the whole optical film structure and reach the substrate.

17. The reflective filter of claim 1, wherein the spacing layer is composed of a first spacing film and a second spacing film in sequence, in that the first spacing film is disposed on the reflective layer while the second spacing film is disposed on the first spacing film.

18. The reflective filter of claim 11, wherein the spacing layer is composed of a first spacing film and a second spacing film in sequence, in that the first spacing film is disposed on the reflective layer while the second spacing film is disposed on the first spacing film.
